(19) United States
(12) Patent Application Publication
(10) Pub. No.: US 2012/0158484 A1
(43) Pub. Date: Jun. 21, 2012

(54) System for use in optimizing advertising delivery for inbound call campaigns

(76) Inventor: Dev Anand Bhatia, Victorville, CA (US)

(21) Appl. No.: 12/928,774

(22) Filed: Dec. 20, 2010

(51) Int. Cl. G06Q 30/00

(52) U.S. Cl. 705/14.42

(57) ABSTRACT

A software-implemented method for delivering advertising presentations in a wide area network (WAN) based on Voice Recognition analysis is described. Data captured through Voice Recognition and other analysis is used to determine which calls contain “success events.” These “success events” are typically sales or other forms of revenue-generating end-user actions. Calls which include “success events,” are grouped into a database, and data in that database is used to determine optimal placement of forthcoming advertising presentations, to maximize the yield of “success events” per every 1,000 advertising presentations shown to end-users. The result is a continuously optimizing method for advertising display across a portfolio of available advertising choices, tied to “success events” identified in the calls themselves.

I claim priority of provisional application No. 61/284,319.

### BACKGROUND OF THE INVENTION

1. Field of the Invention

The present invention relates generally to the field of delivering advertisements to end-users on any Wide-Area Network, including the Internet, with particular applications to Mobile Wide-Area Network end-user presentations.

2. Description of the Related Art

The recent development of the Mobile Internet has provided a new channel for delivery of content to end-users. This content often includes advertisements for products and services for sale to end-users. Often, these advertisements allow end-users to view promotional information, and select displayed “call-now” options to generate voice calls to the advertiser to learn more and purchase a product or service.

In general, prior art Mobile Internet advertising techniques are inefficient and expensive. This is because they fail to optimize for successes, as defined by sales or other “success events”. In particular, the Mobile Internet Advertising industry lacks the ability to track sales or other “success events” in advertising campaigns which generate user response in the form of calls to the advertiser. These advertising methods typically initiate end-user interest by displaying advertising on a content site which is accessed by end-users on their mobile handsets. When end-users select “call-now” options to learn more about a product or service, they effectively switch the interaction from the digital network to a voice network. In doing this, they render as ineffective other online “success event” tracking tools which depend on digital information sessions. These traditional online tracking tools are widely known as “affiliate tracking” or “cookies” or “session cookies”.

As apparent, there is an existing need to provide systems suitable for use in Mobile Internet advertising, and other advertising which is used to generate end user calls, to enable advertising providers to track “success events” such that the advertising is more efficient, less expensive, and more results-oriented.

### BRIEF DESCRIPTION OF THE DRAWINGS

FIG. 1 is an illustrative representation of a network including advertising display, “success event” identification, and feedback to advertising delivery mechanisms.

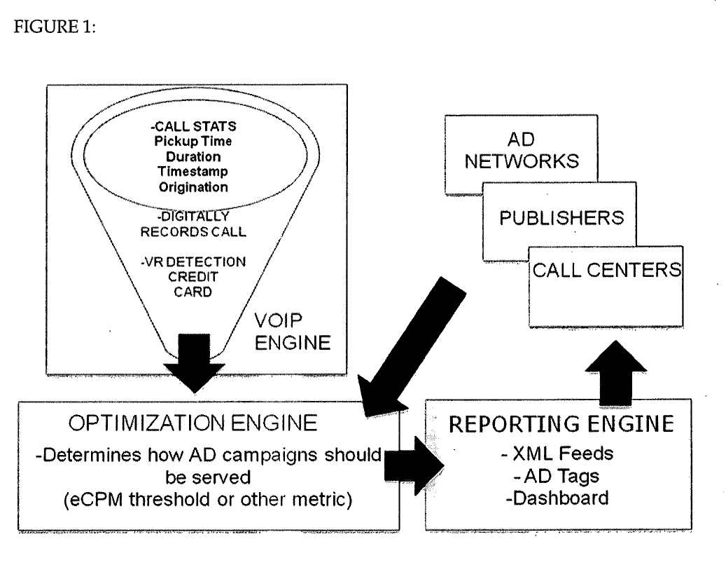

FIG. 2 is an illustrative representation of the invention feature set, and how it is used to optimize display of advertising in mobile content.

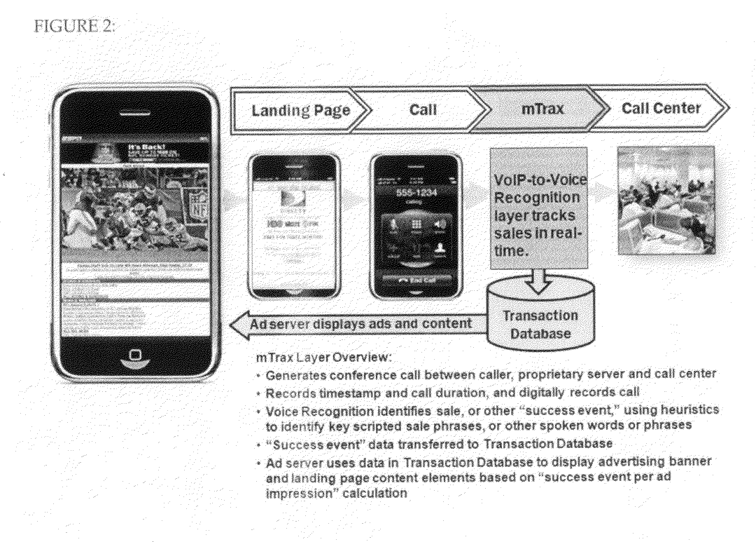

### DESCRIPTION OF THE PREFERRED EMBODIMENT

Methods for use in optimizing advertising delivery for inbound call campaigns are described herein. In the context of Mobile Internet advertising, calls generated by end-users are tracked and measured to identify sale or other “success events”. This identification process is accomplished using multiple criteria, including but not limited to (1) call durations, and (2) data captured using Voice Recognition which correlates to a live sale or other event. Such data includes characteristics which indicate a “success event,” such as the verbal communication of a credit card number during an inbound call, or the verbal communication of a sale confirmation number to the end user. The “VOIP Engine” extracts pertinent characteristics from an incoming end user call—these include, but are not limited to, call duration, geographic location of call, timestamp, gender, accent, call pickup time, and length of time it took for call to occur. In addition, the VOIP Engine applies Voice Recognition analysis to the calls themselves, to determine additional predictors of “success events” in a number of the calls. The “success event” data is later used by the Optimization Engine to best serve and optimize the placement of advertising in a Mobile Internet “Click-to-Call” advertising campaign.

Data, in the form of “success events”, is supplied to the advertising display mechanism which supplies advertising presentations to end-users. Thus linking advertising display with “success events”, this invention enables advertising to be displayed with improving efficiency, such that overall effectiveness is improved. Ideally, the method will yield more “success events” per every 1,000 advertising impressions shown to end-users.

Data is evaluated using an Optimization Engine. The Optimization Engine is a set of software algorithms applied to the aggregated data generated from the incoming call to determine how to more efficiently serve and display advertising presentations used to generate inbound calls from end users.

Information obtained from Optimization Engine is presented to other parties in advertising campaign chain (these include, but not limited to advertising networks, advertising publishers, and call centers) using a Feedback Loop. Information relating to Click-to-Call advertising campaigns from these sources is passed in a feedback loop to better optimize the Click-to-Call campaign. This information includes, but not limited to success of Click-to-Call campaigns resulting in sale, ad inventory, ad pricing, and call quality.

What is claimed is:

1. A method for use in delivering advertising presentations in a Wide Area Network (WAN), the method comprising:
displaying advertising presentations, from one or more servers in a wide area network, to end-users;
receiving, in response to some of the displayed advertising presentations, a number of end-user responses in the form of inbound calls from end users;
identifying sale or other “success event” in a number of the calls generated by end-users using a combination of Voice Recognition analysis and other data analysis;
displaying, from the one or more servers, additional presentations to additional end-users, the additional presentations having been selected for display to end-users based on the results of previous “success event” analysis.

2. The method according to claim 1, wherein the wide area network comprises the Internet.

3. The method according to claim 1, wherein the network comprises a broadcast, cable, or other network, including television, radio, or other network which is used to display advertising presentations to end-users, the method comprising:
displaying advertising presentations, from one or more locations in a network, to end-users;
receiving, in response to some of the displayed advertising presentations, a number of end-user responses in the form of inbound calls from end users;
identifying sale or other “success event” in a number of the calls generated by end-users using a combination of Voice Recognition analysis and other data analysis;
displaying, from the one or more servers, additional presentations to additional end-users, the additional presentations having been selected for display to end-users based on the results of previous “success event” analysis.
